(19) United States
(12) Patent Application Publication
(10) Pub. No.: US 2014/0354434 A1
(43) Pub. Date: Dec. 4, 2014

(54) METHOD AND SYSTEM FOR MODIFYING A MEDIA ACCORDING TO A PHYSICAL PERFORMANCE OF A USER

(71) Applicant: ELECTRIK BOX, Montreal (CA)

(72) Inventor: Olivier LALONDE, Montreal (CA)

(73) Assignee: ELECTRIK BOX, Montreal (CA)

(21) Appl. No.: 14/288,869

(22) Filed: May 28, 2014

Related U.S. Application Data
(60) Provisional application No. 61/828,060, filed on May 28, 2013.

(51) Int. Cl. G08B 21/18; G08B 3/10; G08B 5/00; G06F 17/30

(52) U.S. Cl. CPC G08B 21/18; G06F 17/30017; G08B 3/10; G08B 5/00
USPC 340/573.1

(57) ABSTRACT

There is described a system for modifying a media, comprising: an evaluation unit for receiving a measured performance of a user while performing a physical activity from a performance sensor, comparing the measured performance to a target performance, and upon successful comparison, outputting a command indicative of the successful comparison; and a media modification unit operatively connected to the evaluation unit, for modifying a media to be provided to the user upon reception of the command, and outputting the modified media.

### CROSS-REFERENCE TO RELATED APPLICATIONS

This application claims priority of US Provisional Patent Application having Ser. No. 61/828,060, which was filed on May 28, 2013 and is entitled “Method and system for modifying a media according to a physical performance of a user”, the specification of which is hereby incorporated by reference.

### TECHNICAL FIELD

The present invention relates to the field of methods and systems for modifying a numerical media, and particularly to methods and systems for modifying a numerical media according to a performance of a user during a physical activity.

### BACKGROUND

Some systems exist for helping users to reach a target performance or monitoring a performance of a user during a physical activity. For example, step counting devices or pedometers are used to monitor the number of steps made by a user during a walk or daily activities. In another example, some systems provide the user with a feedback of his actual performance during a physical activity in order to help him maintain a target performance. For example, some systems provide the user with music of which the sound volume depends on the actual performance of the user during the physical activity. However, those systems usually have a limited impact on the user performance.

Therefore, there is a need for an improved method and system for modifying a numerical media according to a performance of a user during a physical activity.

### SUMMARY

In accordance with a first broad aspect, there is provided a system for modifying a media, comprising: an evaluation unit for receiving a measured performance of a user while performing a physical activity from a performance sensor, comparing the measured performance to a target performance, and upon successful comparison, outputting a command indicative of the successful comparison; and a media modification unit operatively connected to the evaluation unit, for modifying a media to be provided to the user upon reception of the command, and outputting the modified media.

In one embodiment, the step of receiving a measured performance comprises receiving one of a frequency of a movement, a pace, a speed, a cadence, and a geographical position for the user.

In one embodiment, the step of comparing the measured performance to a target performance comprises determining whether the measured performance substantially corresponds to the target performance.

In one embodiment, the step of determining comprises determining whether the measured performance substantially corresponds to the target performance for a predetermined number of times.

In another embodiment, the step of determining comprises determining whether the measured performance substantially corresponds to the target performance for a predetermined period of time.

In one embodiment, the method further comprises a step of providing the user with a reference signal indicative of the target performance to be achieved during the physical activity.

In one embodiment, the media comprises one of a video and an interactive book.

In another embodiment, the media comprises an audio file.

In one embodiment, the step of modifying comprises changing a playback position of the audio file.

In one embodiment, the step of changing the playback position is done when a transition time point is reached.

In one embodiment, the audio track comprises a plurality of audio track segments, and the step of modifying comprises one of selecting, adding, and removing a given audio track segment.

In the same or another embodiment, the step of modifying comprises one of modifying, removing, and adding at least one of a volume, an echo, a flanger, a chorus, an equalization, an audio filtering, an overdrive, a pitch shift, time stretching, a pitch, and a saturation.

In another embodiment, the audio track comprises a Musical Instrument Digital Interface (MIDI) audio track, and the step of modifying comprises modifying a parameter of the MIDI audio track, the parameter comprising one of a notation, a pitch, a transposition, a speed, a velocity, a volume, a pan, a vibrato, a sustain, and a tempo.

In one embodiment, the audio track is generated by one of a sound synthesizer, a sampler, and a sound generator unit, the step of modifying comprising modifying one of a pitch, a timber, an oscillator, a overdrive, an envelope, a transposition, a speed, a velocity, a volume, a pan, a vibrato, a sustain, and a tempo of the generated audio file.

According to a second broad aspect, there is provided a system for modifying a media, comprising: an evaluation unit for receiving a measured performance of a user while performing a physical activity from a performance sensor, comparing the measured performance to a target performance, and upon successful comparison, outputting a command indicative of the successful comparison; and a media modification unit operatively connected to the evaluation unit, for modifying a media to be provided to the user upon reception of the command, and outputting the modified media.

In one embodiment, the evaluation unit is adapted to receive one of a frequency of a movement, a pace, a speed, a cadence, and a geographical position for the user.

In one embodiment, the media modification unit is adapted to determine whether the measured performance substantially corresponds to the target performance.

In one embodiment, the media modification unit is adapted to determine whether the measured performance substantially corresponds to the target performance for a predetermined number of times.

In another embodiment, the media modification unit is adapted to determine whether the measured performance substantially corresponds to the target performance for a predetermined period of time.

In one embodiment, the evaluation unit is further adapted to provide the user with a reference signal indicative of the target performance to be achieved during the physical activity.

In one embodiment, the media comprises an audio file.

In one embodiment, the media modification unit is adapted to change a playback position of the audio file.

In one embodiment, the media modification unit is adapted to change the playback position when a transition time point is reached.

In one embodiment, the at least one audio track comprises a plurality of audio track segments, and the media modification unit is adapted to one of select, add, and remove a given audio track segment.

In the same or another embodiment, the media modification unit is adapted to one of modify, remove, and add at least one of a volume, an echo, a flanger, a chorus, an equalization, an audio filtering, an overdrive, a pitch shift, time stretching, a pitch, and a saturation of the audio track.

In another embodiment, wherein the audio track comprises a Musical Instrument Digital Interface (MIDI) audio track, and the media modification unit is adapted to modify a parameter of the MIDI audio track, the parameter comprising one of a notation, a pitch, a transposition, a speed, a velocity, a volume, a pan, a vibrato, a sustain, and a tempo.

In another embodiment, the audio modification unit comprises one of a sound synthesizer, a sampler, and a sound generator unit, and the media modification unit is adapted to modify one of a pitch, a timber, an oscillator, a overdrive, an envelope, a transposition, a speed, a velocity, a volume, a pan, a vibrato, a sustain, and a tempo of the generated audio file.

According to a further broad aspect, there is provided a computer program product comprising a computer readable memory storing computer executable instructions thereon that when executed by a computer perform the steps of: receiving from a performance sensor a measured performance of the user while performing a physical activity; comparing the measured performance to a target performance; upon successful comparison, modifying the media to be provided to the user; and outputting the modified media.

### BRIEF DESCRIPTION OF THE DRAWINGS

Further features and advantages of the present invention will become apparent from the following detailed description, taken in combination with the appended drawings, in which:

FIG. 1 is a block diagram of a system for modifying a numerical media according to a performance of a user during a physical activity, in accordance with an embodiment;

FIG. 2 is a flow chart illustrating a method for modifying a numerical media according to a performance of a user during a physical activity, in accordance with an embodiment;

FIG. 3 is an exemplary graph of a measured cadence of a user as a function of time for which a single match with a target cadence occurs;

FIG. 4 is an exemplary graph of a measured cadence of a user as a function of time for which two matches with a target cadence occur;

FIG. 5 illustrates an audio signal divided into sequences, clips, regions and media track segments, in accordance with an embodiment;

FIG. 6 illustrates an actual playback position and a target playback position positioned on an audio track, in accordance with an embodiment;

FIG. 7 illustrates an actual playback position, a transition playback position, and a target playback position positioned on an audio track, in accordance with an embodiment;

FIG. 8 illustrates a switching of two regions of an audio track, in accordance with an embodiment;

FIG. 9 illustrates an increase of the a duration of a region of an audio track, in accordance with an embodiment; and

FIG. 10 illustrates the replacement of a first media segment by a second and different media segment, in accordance with an embodiment.

It will be noted that throughout the appended drawings, like features are identified by like reference numerals.

### DETAILED DESCRIPTION

FIG. 1 illustrates one embodiment of a system 10 for modifying a media provided to a user according to the performance of the user during a physical activity. The system 10 comprises an evaluation unit 12 and a media modification unit 14 operatively connected to the evaluation unit 12.

The evaluation unit 12 is in communication with a performance sensor 16 which is adapted to measure a performance of the user while performing a physical activity. The evaluation unit 12 is adapted to receive the measurement of a user performance from the performance sensor 16, and compare the received measured performance to a performance target.

It should be understood that both the evaluation unit and the performance sensor are each provided with a communication unit for communicating together. For example, they may be each provided with a wireless communication unit.

If the measured performance substantially corresponds to the performance target, then the evaluation unit 12 outputs, to the media modification unit 14, a command indicative that the performance target has been reached.

Upon reception of the command from the evaluation unit 12, the media modification unit 14 is adapted to modify a media to be provided to the user. The modified media is sent to a media providing unit 18 adapted to provide the user with the modified media in an adequate format.

In one embodiment, the media to be modified comprises an audio file and the media providing unit 18 comprises speakers, a headset, and/or the like. It should be understood that the audio file may comprise a Musical Instrument Digital Interface (MIDI) file. The audio file may be an independent audio file containing a song for example, the audio track of a video, the audio track of a video game, and/or the like.

In one embodiment, the media modification unit 14 may be a sound synthesizer, a sampler, or a sound generator adapted to generate an audio file and output the audio file as an audio signal. The audio signal may be sent to speakers for example. In this case, the media modification unit 14 is adapted to generate in substantially real-time an audio signal that is sent to the user and, upon reception of the command indicative that the performance target has been reached, the media modification unit 14 changes in substantially real-time the pitch, the timber, the oscillator, the overdrive, the envelope, the transposition, the speed, the velocity, the volume, the pan, the vibrato, the sustain, and/or the tempo of the audio signal being generated.

In another embodiment, the media to be modified comprises a video file or an interactive book, and the media providing unit 18 comprises a display unit. An interactive book is a digital book which requires participation from a reader and allows the reader to interact with the digital book. If the video file or the interactive book comprises at least one audio track, the media providing unit 18 further comprises at least one speaker, a headset, etc.

In an embodiment in which the media to be provided to the user is a video, the media modification unit 14 is adapted to change a playback position of the video file. For example, a playback position for a video may be identified by a given chapter, a given time, a given frame, a given region, a given sequence, a given clip, a given beat, and/or the like. For example, the playback position may be changed from a current playback position such as video frame 33 to a target playback position such as frame 44.

Still in an embodiment in which the media to be provided to the user is a video, the video comprises a sequence of video regions or segments and the media modification unit 14 is adapted to add, select, replace or remove a given video segment of the video sequence. For example, upon reception of the command from the evaluation unit 12, the media modification unit 14 may be adapted to replace the first video segment by the fourth video segment of the sequence.

In an embodiment in which the media to be provided to the user is an interactive book, the media modification unit 14 is adapted to change a playback position of the interactive book. The playback position may be represented by a given chapter, a given time, a given frame, a given region, a given sequence, a given clip, a given beat, a given page index, or the like. For example, upon reception of the command from the evaluation unit 12, the media modification unit 14 may be adapted to change the playback position from page 45 to page 22.

Still in an embodiment in which the media to be provided to the user is an interactive book, the media modification unit 14 is adapted to add, select, replace or remove a media of the interactive book. For example, the media modification unit 14 may be adapted to add a given image to a given target.

In a further embodiment, the media to be modified comprises at least one image and the media providing unit 18 comprises a display unit.

In one embodiment, the performance sensor 16 is adapted to measure the frequency of a body motion or movement while the user is performing a physical activity. For example, the user may be walking or running. In this case, the performance sensor is adapted to measure the number of strides per time unit such as the number of strides per minute. It should be understood that the frequency may correspond to the frequency of movement of any adequate body part(s). For example, the frequency may correspond to the frequency of movement of the user leg(s), the user arm(s), the user trunk, the user head, and/or the like. A frequency of movement may be measured while the user is performing physical activities such as walking, jogging, skiing, biking, skating, boxing, performing martial arts, and/or the like.

In another embodiment, the performance sensor is adapted to measure a pace or a speed of the user. For example, the performance sensor may be adapted to measure the pace or speed of the user while running, walking, skiing, or the like.

In a further embodiment, the performance of the user correspond to a geographical position.

In one embodiment, the performance sensor may comprise a Global Positioning System (GPS), an accelerometer, a gyroscope, an odometer, a piezometer, a light sensor, a video sensor, and/or the like for measuring the user performance.

In one embodiment, the performance sensor 14 is adapted to substantially continuously measure the user performance and transmit it to the evaluation unit 12. In this case, the evaluation unit 12 substantially continuously receive the value of the measured performance. In another embodiment, the performance sensor 14 is adapted to measure the performance of the user at predetermined points in time, such as every 5 seconds. In this case, the evaluation unit 12 receives discrete values of the measured performance.

The evaluation unit 12 is adapted to receive the target performance and compare the measured performance to the target performance. The target performance is stored in a storing unit that is accessible by the evaluation unit 12. The storing unit may be internal to the evaluation unit 12. Alternatively, the storing unit may be external to the evaluation unit 12.

In one embodiment, the evaluation unit 12 is adapted to compare the measured performance to the target performance. If the measured performance substantially correspond to the target performance, the evaluation unit 12 outputs a command indicative of the positive match to the media modification unit 16. It should be understood that in case of negative match, the evaluation unit 12 may be adapted to transmit no command to the media evaluation unit 14. Alternatively, the evaluation unit 12 may be adapted to output a command indicative of a negative match to the media modification unit 14. In an example in which the movement frequency corresponds to a number of strides per minute (SPM) and the target performance is set to 90 SPM, the evaluation unit outputs a command indicative of a positive match only when the measured frequency substantially correspond to 90 SPM.

In another embodiment, the evaluation unit 12 is adapted to compare the measured performance to a range of values centered on the target performance, e.g. the target performance±10% for example. If the measured performance is within the range of target values, then the evaluation unit 12 determines that a positive match occurs. If the measured performance is outside the range of target values, the evaluation unit 12 determines that no match occurs. In an example in which the movement frequency corresponds to a walk or run frequency (hereinafter referred to as a cadence) measured in SPM, the target performance may be set to 90 SPM±5 SPM. If the measured cadence is comprised within 85 SPM and 95 SPM, then the evaluation unit 12 determines that a match occurred. Alternatively, the evaluation unit 12 determines that no match occurred.

In a further embodiment, the measured performance must be substantially equal to the target performance for a predetermined period of time so that the evaluation unit 12 determines a positive match. It should be understood that the measured performance may be within a predetermined performance range so that a positive match occurs.

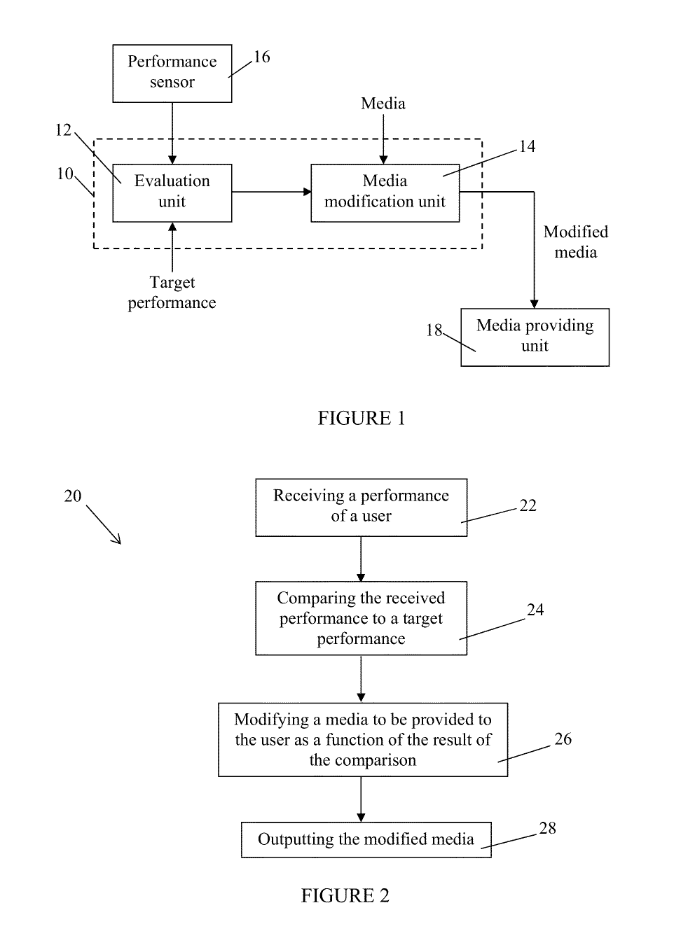

It should be understood that the system 10 may be embodied as a computer-implemented method 20 for modifying a media according to a performance of a user during a physical activity as illustrated in FIG. 2. At step 22, a measurement of a performance of a user is received from a performance sensor 16. At step 24, the received performance is compared to a target performance as further explained within the present description. At step 26, a media to be provided to the user is modified according the result of the comparison, as further explained in the present description. At step 28, the modified media is outputted in order to be provided to the user.

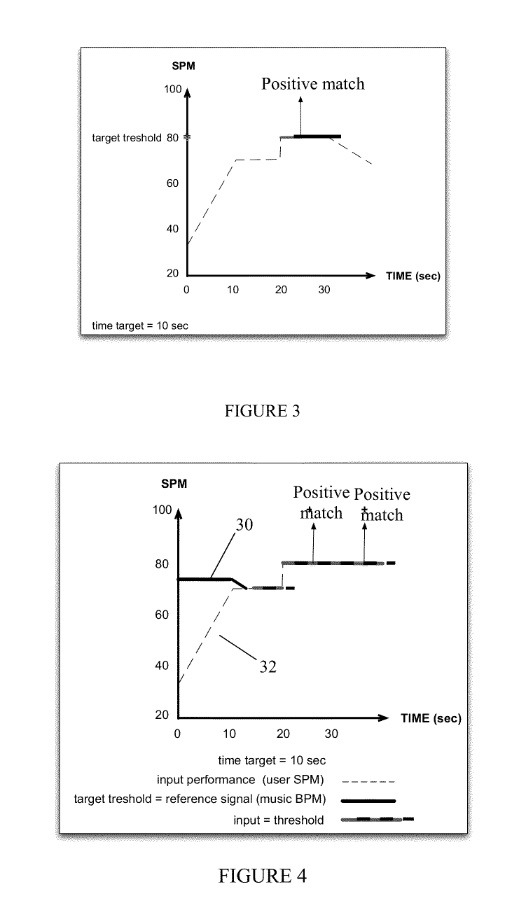

FIG. 3 illustrates one example in which the cadence of a user is measured by the performance sensor 16. In this case, the graph illustrated in FIG. 3 presents the cadence of the user as a function of time and the target cadence is set to 80 SPM. In order to obtain a positive match, the user must maintain the target cadence for a continuous period of 10 s. As illustrated in FIG. 3, the measured cadence is substantially equal to 80 SPM between 20 s and 30 s. Therefore, the evaluation unit 12 determines that a positive match occurred for a period of 10 s and outputs a command indicative of the positive match.

In still a further embodiment, the user must reach the target performance a predetermined number of times so that a positive match is determined by the evaluation unit 12. For example, the following sequence of discrete values for the measured cadence (in SPM) is received by the evaluation unit 12: 78, 80, 80, 80, 82, and 80. If the target cadence is set to 80 SPM and a positive match occurs when the measured cadence has reached the target cadence four times. In this case, the evaluation unit 12 outputs a command indicative of a positive match since the sequence of measured cadences comprises four times the target cadence value, i.e. 80 SPM. In another example, a positive match may occur only when the measured cadence is substantially equal to the target cadence for a consecutive number of times, such as four consecutive times. In this case, the evaluation unit 12 does not determine a positive match since the sequence of measured cadences comprises only three consecutive times the value of the target cadence.

In another embodiment, the target performance corresponds to a threshold so that a positive match occurs when the measured performance is above the performance target. Alternatively, a positive match may occur when the measured performance is below the target performance.

It should be understood that the target performance value may vary in time so that the target performance value at the beginning of the physical activity and that at the end of the physical activity, for example, may be different. For example, the target performance may be set as a function of a reference signal which is provided to the user.

In one embodiment, a reference signal is provided to the user to help him reach and maintain the target performance. A characteristic of the reference signal is then varied to reflect the change in the performance target. For example, a characteristic or parameter of the reference signal may be increased when the value of the performance target increases. The characteristic of the reference signal may also be decreased when the value of the performance target decreases. In one embodiment, the rate of change of the value of the performance target may be applied to the characteristic of the reference signal, e.g. if the performance target increases by 10%, the characteristic of the reference signal is increased by 10%.

For example, the reference signal may be a visual signal provided by a display unit, a light source, or the like, and a characteristic of the reference signal varies as a function of the target performance for the user. For example, the visual reference signal may comprise light pulses of which the pulse frequency may change in time to correspond to the time-varying target performance to be reached by the user. In another example, the color of a light may change at a frequency that corresponds to that of the time-varying target performance.

In another embodiment, the reference signal may be an audio signal provided to the user. For example, the audio reference signal may be a metronome, a rhythm, a music, a pulse sound, or the like, of which a characteristic is changed at a rate that corresponds to the time-varying target performance to be reached by the user. For example, the number of beats per minute (BPM) of a metronome signal may be changed to correspond to the time-varying target performance. When the value of the target performance to be reached by the user increases, the number of BPM of the metronome signal is increased. Similarly, when the value of the target performance to be reached by the user decreases, the number of BPM of the metronome signal is decreased.

FIG. 4 illustrates one example in which a metronome reference signal is provided to the user to help him reach a target performance which varies in time. The target performance may be a target cadence expressed in SPM. For each value of the target performance in time, a corresponding BPM value is determined for the metronome reference signal. Therefore, the reference metronome signal may be expressed in BPM, but also in SPM as illustrated by curve 30 in FIG. 4. When the measured cadence 32 corresponds to the reference metronome signal 30 expressed in SPM for a continuous period of 10 s, the evaluation unit 12 determines a positive match.

In a further embodiment, the reference signal is a tactile reference signal applied to the user. For example, vibrations may be applied to the user and the frequency of the vibrations substantially correspond to the target performance to be reached by the user. In another example, pressure may be applied to the user. In this case, the amplitude of the pressure is varied to correspond to the target performance to be reached by the user.

In one embodiment, the evaluation unit 12 is further adapted to provide a score or points each time a positive match occurs between the measured performance and the target performance. The evaluation unit 12 is further adapted to add the scores or points obtained over a given period of time. When the total score or total number of points equals to a target score or a target number of points, respectively, the evaluation unit 12 determines that a positive match occurred and outputs a command indicative of a positive match to the media modification unit 14.

In an embodiment in which the evaluation unit 12 is adapted to compare the measured performance to a range of target performance, the score or number of points assigned to the user may depend on the difference between the measured performance and the center value of the range of target performance. For example, the closer the measured performance is from the center value, the greater the score assigned to the user is.

In one embodiment, the target performance is user-independent, i.e. it is the same for all users. In another embodiment, the target performance is user-specific. For example, the storing unit may have stored thereon a user profile comprising user information such as the user age, weight, height, fitness condition, preferences, and/or the like. In this case, the evaluation unit may be adapted to modify an initial and user-independent target performance according to the user information. For example, a first user who is older than a second user may have a lower target performance than the second user.

Referring to the media modification unit 14, different types of modification to the media may be performed by the media modification unit 14. In one embodiment, the type of modification is determined by the user. In another embodiment, the media modification unit 14 is adapted to randomly determine the type of modification to be done to the media. In a further embodiment, the media modification unit 14 is adapted to determine the type of modification to be done to the media as a function of the value of the target performance achieved by the user. In this case, the evaluation unit 12 is further adapted to transmit the target performance reached by the user in addition to the command indicative that the target performance has been reached. In this case, the media modification unit 14 may comprise a database in which each target performance is associated with a corresponding type of media modification. The media modification unit 14 then accesses the database to retrieve the media modification type that corresponds to the received target performance. In still another embodiment, the media modification unit 14 is adapted to determine the type of modification to be done to the media according to the user previous performances stored in the user database. The rules for determining the type of modification to be done are stored in the database. For example, a user may obtain a score of 88 points on a first day, 33 points on a second day, and 122 points on a third day, for a total number of points of 243 points and an average number of points of 81 points. For example, two modification rules may be the following: 1—if the average number of points is at least equal to 82 points, then apply a given audio processing; 2—if the total number of points is at least equal to 66 points, then modify MIDI sequence.

In still another embodiment, the type of media modification is determined as function of time such as the absolute time, the music time, the video time, etc. In this case, the media modification unit 14 comprises a database in which each time point is associated with a corresponding type of media modification.

In still a further embodiment, the type of modification is determined as a function of the value of a specific parameter of the signal. For example, in the case of an audio signal, the type of modification to be done may depend on the value of parameters such as a peak amplitude value, a number of voice, the duration of a silence. In the case of a video signal, the type of modification to be done may depend on the value of parameters such as a contrast value, a black value, a number of frames per second, etc.

In one example, the signal modification is triggered by the value of the amplitude peak of an audio signal. For example, when the amplitude peak reaches −1 dB, a predetermined distortion is applied of the audio signal. When the peak amplitude reaches −3 dB, reverb is applied to the audio signal. In another example, the user must first reach a predefined number of points before the peak amplitude is compared to thresholds in order modify the audio signal.

In one embodiment, a media file comprises at least one track. The tracks may comprise audio tracks, MIDI tracks, video tracks, series of images, and/or the like.

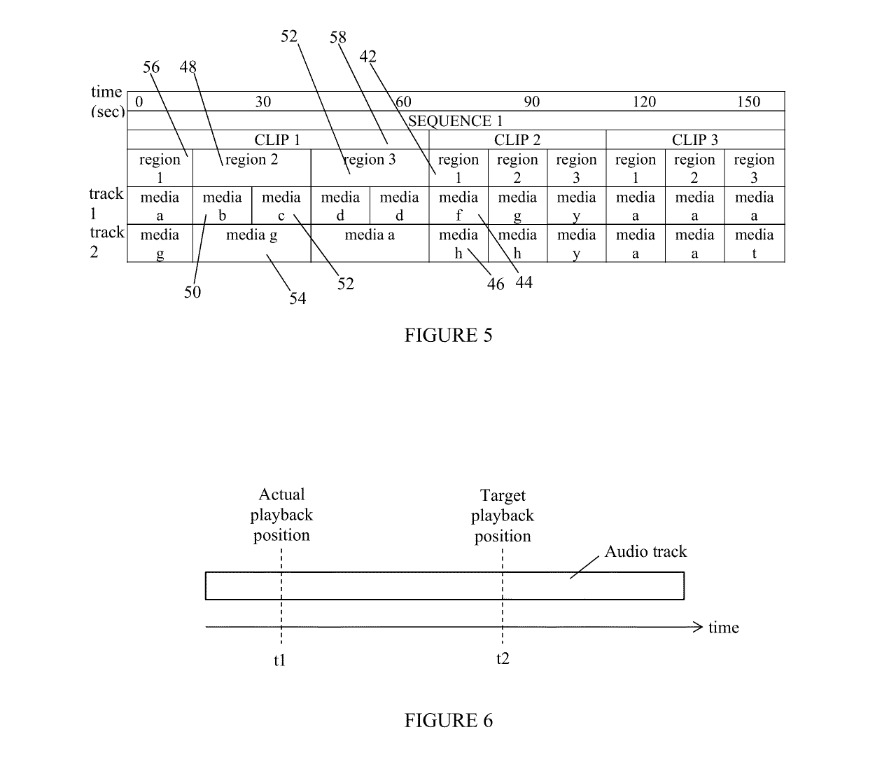

As illustrated in FIG. 5, each track is segmented into a plurality of media track segments 40. A region may correspond to only one media track segment. For example, region 42 only corresponds to media track segment 44 of the first track, referred hereinafter as the first media track segment 44, and to media track segment 46 of the second track, referred hereinafter as the second media track segment 46. In this case, the start point in time of the region 42 corresponds to that of the first and second media track segments 44 and 46, and the end point in time of the region 42 corresponds to that of the first and second media track segments 44 and 46, so that the time duration of the region 42 corresponds to that of the first and second media track segments 44 and 46.

Alternatively, a region may corresponds to more than one media track segment. For example, region 48 corresponds to two successive media track segments 50 and 52 for the first track and further corresponds to a single media track segment 54 of the second track. In this case, the start point in time of the region 48 corresponds to that of the media track segment 50 for the first track and that of the media track segment 54 for the second track. The end point in time of the region 48 corresponds to that of the second media track segment 52 for the first track and that of the media track segment 54 for the second track. As a result, the time duration of the region 48 corresponds to that of the media track segment 54 and to the addition of the time durations of the media track segments 50 and 52.

Successive regions are regrouped into clips, and successive clips are regrouped into sequences. For example, regions 56, 48, and 58 may be regrouped to form clip 1, and clips 1, 2, and 3 may be regrouped to form a first sequence, i.e. sequence 1 which is a logically ordered set of media track segments.

It should be understood that the media track segments contain audio data when the media to be modified is an audio media. The media track segments contain data about score, notation, pitch, MIDI controllers, and/or the like when the media to be modified is a MIDI media. The media track segments contain video data such as images when the media to be modified is a video. Optionally, the video file may comprise an audio track. In this case, the video file comprises audio track segments that form together an audio track. Similarly to a video file, the segments for an interactive book comprises image data and may also contain audio data.

The media modification unit 14 is adapted to receive a media file and modify the media file upon reception of a command indicative that the user has reached a target performance from the evaluation unit 12. The media file may be stored in a storing unit which may be internal to the media modification unit 14 or external to the media modification unit 14. In another example, the media modification unit 14 may comprise a communication unit for receiving the media file to be modified that is streamed from a server on which it is stored.

When the media to be modified contains at least an audio track, the media modification unit 14 is adapted to act as a sequencer, i.e. it is adapted to record, edit, and/or play back an audio file. The media modification unit 14 is further adapted to modify the audio file, as described below.

When the media to be modified corresponds to a video file, the media modification unit 14 is adapted to play back video in addition to modify the video file. The media modification unit 14 may be further adapted to play back and modify audio files if the video comprises an audio track for example.

In the following, the operation of the media modification unit 14 for modifying a media file is described with respect to the modification of an audio file. However, it should be understood that the same principles may be applied to the modification of other types of media such as video files or interactive book files.

In one embodiment, the media modification unit 14 is adapted to modify the time position of the playback of the audio file. During the playback of the an audio file, the media modification unit 14 is adapted to jump the playback of the audio file from the actual playback position or point in time to a target playback position or point in time. For example, FIG. 6 illustrates one embodiment of an audio track that is played back by the media modification unit 14. When the play back of the audio track is at the actual playback position, i.e. at time position t1, the media modification unit 14 receives a command indicative that the user reached a target performance. Then the media modification unit 14 determines the target playback position from which the playback of the audio track should be continued, and moves the playback of the audio track from the actual playback position to the target playback position, i.e. from the time position t1 to the time position t2.

While in the above example the target playback position is located at a time position t2 that is greater or later than the actual playback position, it should be understood that the target playback position may be located at a time position that is less or earlier than the actual position. For example, a user may be required to maintain a physical activity performance above a given threshold during a physical activity. If the measured performance decreases below the given threshold, a command is sent from the evaluation unit 12 to the media modification unit 14. Upon reception of the command, the media evaluation unit 14 moves the playback of the audio track to the beginning of the audio track for example. If the audio track corresponds to a song, then the user is obliged to maintain the performance above the threshold if he wants to listen to the entire song. If his performance decreases below the given threshold, then the song is played back from the beginning.

In one embodiment, the media modification unit 14 is adapted to repeatedly playback a given media segment, region, or clip until a command is received. Upon reception of the command, the media modification unit 14 stops playing back the given media segment and moves the playback of the audio track to the target playback position. The target playback position may be the beginning of the next media segment, region, or clip for example. In another example, the target playback position may be the beginning of a previous media segment, region, or clip. It should be understood that the number of repetition may be predetermined. In this case, when the number of repetition has reached the predetermined number without having the user reaching the performance target, the media modification unit 14 moves the playback of the audio track to the next media segment, region, or clip.

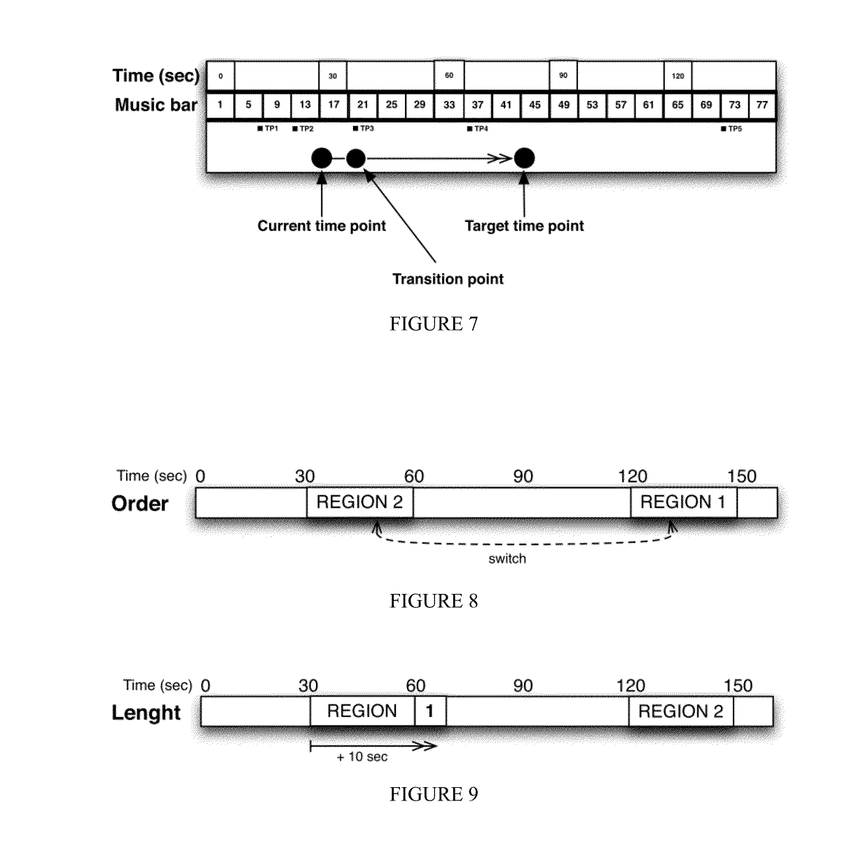

As described above, the media modification unit 14 may be adapted to move the playback of the audio track from the actual playback position to the target position upon reception of the command from the evaluation unit 12. In another embodiment, the media modification unit 14 is adapted to first playback the audio track until a transition playback position, and then moves the playback of the audio track from the transition playback position to the target playback position, as illustrated in FIG. 7. The transition playback point may be the start or end point of a given media track segment, region, or clip.

In one embodiment, the target playback point is the start point of a media track segment, a region, a clip, or a segment. In another embodiment, the target playback point is positioned within a media track segment and is different the start and end points of the media track segment.

In one embodiment, the target playback points are stored in a database along with the audio file. For example, an ordered list of target playback points may be stored in memory. Similarly, an ordered list of transition playback position may also be stored in memory. In this case, upon reception of a first command, the media modification unit 14 moves the playback of the audio file from the actual playback position or a first transition playback position to the first target playback position of the list of target positions. Upon reception of a second command, the media modification unit 14 moves the playback of the audio file from the actual playback position or a second transition playback position to the second target playback position of the list of target positions, etc. In one embodiment, the transition and/or target playback positions are determined by the user and stored in memory. In another embodiment, the database may comprise a corresponding transition and/or target playback position for each time position of the audio track. In this case, upon reception of a command from the evaluation unit 12, the media modification unit 14 is adapted to retrieve, from the database, the transition and/or target playback position that corresponds to the actual playback position, and modify the playback accordingly.

In an embodiment in which the evaluation unit 12 is adapted to transmit the target performance that has been reached by the user along with the command, the database may comprise a corresponding transition and/or target playback position for each performance target. In this case, the media modification unit 14 is adapted to retrieve, from the database, the transition and/or target playback position that correspond to the actual playback position at which the command is received from the evaluation unit 12.

In an embodiment in which the evaluation unit 12 is adapted to determine and transmit a core or number of points, the media modification unit 14 may be adapted to modify or create a transition and/or target playback point as function of the received score or number points.

In one embodiment, a target or transition position may be the next time unit value such as the next second, the next minute, the next hour, etc. In another embodiment, target or transition point may be the next note value such as the next whole note, the next half note, the next quarter note, the next eight note, the next bar, the next measure, etc. In an embodiment in which the media to be modified is a video file, the target or transition playback position may be the next frame, the next feet, the next picture, the next image, etc.

In another embodiment, the media modification unit 14 is adapted to determine substantially randomly the transition and/or target playback positions.

In one embodiment, the media modification unit 14 is adapted to modify the order of the media segments, regions, clips or sequences, upon reception of a command indicative that the performance target has been reached. For example, the media modification unit 14 may be adapted to switch two regions together as illustrated in FIG. 8.

In one embodiment, the media modification unit 14 is adapted to increase the temporal duration of a media segment, region, clip or sequence, upon reception of a command indicative that the performance target has been reached. For example, the media modification unit 14 may be adapted to increase the temporal duration of a given region by 10 s, as illustrated in FIG. 9.

The increase of the temporal duration of a given region may be achieved using any adequate method such as by time-stretching, pitch shifting, adding a predetermined media, duplicating a portion of the media, etc.

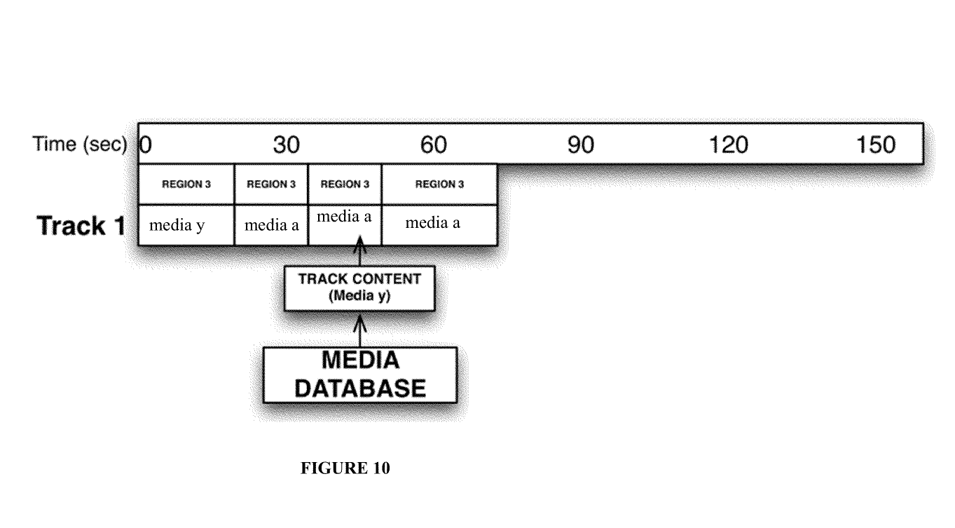

In one embodiment, the media modification unit 14 is adapted to replace a given track segment, region, clip or segment by another predetermined track segment, region, clip or segment, respectively, upon reception of a command indicative that the performance target has been reached. For example, a media track segment a may be replaced by a media track segment y, as illustrated in FIG. 10.

In one embodiment, the media modification unit 14 is adapted to stop the playback of the audio track upon reception of a command indicative that a target performance has been reached. For example, when the measured performance for a user is below a given threshold performance, the media modification unit 14 is adapted to stop the playback of the audio track. When the measured performance increases above the performance threshold, the media modification unit 14 is adapted to restart the playback of the audio file.

In one embodiment, the media modification unit 14 is adapted to add or remove a track from the audio file to be modified upon reception of a command indicative that the measured performance has reached the target performance. In one embodiment, the track to be added or removed is determined substantially randomly by the media modification unit 14. In another embodiment, a database comprises a corresponding track to be added or removed for each time point of the audio file. In this case, the media modification unit 14 is adapted to retrieve the track to be added or removed that corresponds to the actual playback position from the database, and subsequently add or remove the retrieved track. In a further embodiment in which the evaluation unit 12 is adapted to output the performance target that has been reached or a score, a database may comprise a corresponding track to be added or removed for each performance target or score. In this case, the media modification unit 14 is adapted to retrieve the track to be added or removed that corresponds to the received performance target or score from the database, and subsequently add or remove the retrieved track.

For example, before the beginning of each song, the system may play a metronome sound for a few seconds so that the user may match his running cadence to the reference rhythm. When the user's cadence matches the rhythm of the music, the user accumulates points. During the pre-track region, the user must accumulate a predetermined target number of points to progressively unlock each of four tracks (interactive mixing), for example. The four tracks may be: drum, bass, harmony (guitar, synth, rhythm, etc.), and lead (vocal, instrument, etc.). If the user does not have enough points, the pre-track region will loop. When the user has unlock the four tracks and has accumulated enough points, the sequencer go to the next music part (interactive sequencing). If user does not have enough points the music part region will loop. Furthermore, the system may mute tracks when the user's performance decreases.

In one embodiment, the track to be added comprises vocal interventions from a virtual coach. Interventions from the virtual coach can be mixed dynamically with the music.

In one embodiment, the media modification unit 14 is adapted to send a further media to the media providing unit 18. For example, the further media may be a sound, a picture, a video, or the like. In one embodiment, the further media is retrieved substantially randomly from a database of medias. In another embodiment, a database comprises a corresponding further media for each time point of the audio file. In this case, the media modification unit 14 is adapted to retrieve the further media that corresponds to the actual playback position from the database, and subsequently provide the further media to the user. In a further embodiment in which the evaluation unit 12 is adapted to output the performance target that has been reached or a score, a database may comprise a corresponding further media for each performance target or score. In this case, the media modification unit 14 is adapted to retrieve the further media that corresponds to the received performance target or score from the database, and subsequently provide the user with the further media.

In one embodiment, the media modification unit is adapted to apply a digital signal processing the media to be modified. It should be understood that the digital signal processing may be added to any above-described modification.

In an embodiment in which the media to be modified comprises at least one audio track, the media modification unit 14 is adapted to modify a characteristic of the audio signal to be provided to the user and/or apply an audio effect to the audio signal, upon reception of the command indicative that the performance threshold has been reached. For example, the media modification unit 14 may be adapted to modify or add at least one of the volume, echo, flanger, chorus, equalization, audio filtering, overdrive, pitch shift, time stretching, pitch, saturation such as low frequency saturation, and/or the like.

In an embodiment in which the media to be modified comprises a MIDI track, the media modification unit 14 is adapted to modify at least one MIDI characteristic, upon reception of the command indicative that the performance threshold has been reached. For example, the media modification unit 14 may be adapted to modify at least one of the notation, pitch, transposition, speed, velocity, volume, pan, vibrato, sustain, tempo, etc.

In an embodiment in which the media to be modified comprises a video file or images, the media modification unit 14 is adapted to modify at least one characteristic of the video track or images, upon reception of the command indicative that the performance threshold has been reached. For example, the brightness, opacity, contrast, filtering, motion, zoom, aspect ratio, frame per second rate may be changed.

In one embodiment, the type of digital signal processing to be applied to the media is determined substantially randomly by the media modification unit 14. In another embodiment, the type of digital signal processing to be applied by the media modification unit 14 depends on the actual playback position at which the command indicative that the target performance has been reached is received by the media modification unit 14. In a further embodiment, the type of digital signal processing to be applied by the media modification unit 14 depends on the performance target or score received from the evaluation unit 12.

In one embodiment, the type of digital signal processing to be applied to the media is selected by the user. In this case, the media modification unit 14 is adapted to receive a command entered by the user using an input device. The user command is indicative of the type of modification to be made to the media.

In one embodiment, the media modification unit 14 is further adapted to control the time duration during which the modification of the media is performed. For example, the media modification unit 14 may be adapted to apply the modification to the media for a predetermined period of time. In another example, the media modification unit 14 may apply modify the media until a predetermined threshold point in time be reached, until a predefined score be reached, and/or the like. It should be understood that the predetermined time duration, the predetermined threshold point in time, or the predefined score is stored in memory which is accessible by the media modification unit 14.

In one embodiment, the system 10 further comprises a user database in which information about the user is stored. For example, personal information such as age, weight, height, physical condition, etc. of the user is stored in the database. The database may also comprise synchronism reference history. For example, the percentage of accuracy (SPM vs. a song reference) can be found in the user database. In another example, the user heartbeat (BPM) vs. light pulsing (BPM) is stored in the database. User preferences may also be stored in the database. For example, media x has been played 32 times in the last week. Media x and media y have been played 3 times during the last month.

In one embodiment, the system 10 comprises a group database for storing information about a group of users. The group database may comprise the same information as the user database for each user. In addition, the group database may comprise group information such as an average age, an average synchronism reference history, etc.

In one embodiment, the evaluation unit 12 is adapted to evaluate an activity performance for at least two users. In this case, each user is provided with a respective performance sensor 16. The monitored performance may be the same for all users. Alternatively, each user may be assigned a respective performance to be monitored.

In one embodiment, the evaluation unit 12 is adapted to determine an average measured performance using the measured performance received from the performance sensors of the users. The evaluation unit 12 then compares the average performance to the target performance. Upon successful comparison, the evaluation unit 12 outputs a command indicative that the group of users has reached the target performance. In another embodiment, the evaluation unit 12 may use the lowest performance value or the highest performance value of the group of users to perform the comparison with the target performance.

In another embodiment, the measured performance of a first user may be used to modify the media provided to a second user. In this case, the measured performance of the first user is compared to a threshold which may be specific to the user of the group of users. Upon successful comparison, a command is sent to the media modification unit 14 which modifies the media provided to the second user.

It should be understood that the media modification unit 14 may be adapted to provide all users of a group with a same media. In another embodiment, the media modification unit 14 may be adapted to provide each user with a user-specific media.

In one embodiment, the evaluation unit 12 is adapted to determine the performance target for a user according to a training program. An exercise routine consists of a set of temporal activity patterns, which are defined by variation in target steps-per-minute (SPM). Depending on the character of the associated activity patterns, a routine can consist of several exercise elements, including intervals (with variable intensity and duration), long distance running, ramps, etc.

For example, the evaluation unit 12 may evaluate the user cadence for a predetermined period of time. The evaluation unit 12 determines that the user base cadence average in 75 SPM. The evaluation unit 12 then sets the final target cadence to 85 SPM. A target time to reach the target cadence is inputted in the evaluation unit 12, e.g. 4 weeks. The evaluation unit 12 then determines the target cadence for each week, such as:

Week 1: Base cadence (70)

Week 2: Base cadence+5 (75)

Week 3: Base cadence+5 (80)

Week 4: Base cadence+5 (85)

The system uses the target SPM of the exercise routine over time to generate the music playback program. During the training, the target SPM value is compared to the music tempo in BPM and the system modifies the playback rate of the associate audio files in real-time without modifying the pitch in order to sync with the target SPM.

In one embodiment, the system further comprises a movement sensor adapted to detect a movement of the user and apply a predetermined processing to the media upon detection of a respective movement performed by the user. For example, the system may detect that the user raises his left arm and triggers a corresponding processing of the media.

It should be understood that the evaluation unit 12 and the media modification unit 14 may be independent from one another. In this case, the evaluation unit 12 and the media modification unit 14 are each provided with a processing unit, a memory, and a communication unit for receiving and transmitting data. In this case, instructions for comparing the received performance to a target performance are stored on the memory of the evaluation unit 12, and the processing unit of the evaluation unit 12 is adapted to execute the instructions in order to compare the received performance to the target performance, as described above. Furthermore, instructions for modifying a media to be provided to the sure are stored on the memory of the media modification unit 14, and the processing unit is adapted to execute the instructions in order to modify the media as described above.

In another embodiment, the evaluation unit 12 and the media modification unit 14 are part of a same unit and share a same processing unit, a same memory, and a same communication unit. In this case, the instructions for evaluating the received user performance and modifying the media to be provided to the user are stored on the same memory, and the processing unit is adapted to execute the instructions in order to both compare the received user performance to a target performance and modify the media, as described above.

In one embodiment, the above-described method and system are embodied as a computer program product comprising a computer readable memory storing computer executable instructions thereon that when executed by a computer perform the steps of the method 20.

The embodiments of the invention described above are intended to be exemplary only. The scope of the invention is therefore intended to be limited solely by the scope of the appended claims.

I/We claim:

1. A computer-implemented method for modifying a media to be provided to a user, comprising:
receiving from a performance sensor a measured performance of the user while performing a physical activity;
comparing the measured performance to a target performance;
upon successful comparison, modifying the media to be provided to the user; and
outputting the modified media.

2. The computer-implemented method of claim 1, said receiving a measured performance comprises receiving one of a frequency of a movement, a pace, a speed, a cadence, and a geographical position for the user.

3. The computer-implemented method of claim 1, wherein said comparing the measured performance to a target performance comprises determining whether the measured performance substantially corresponds to the target performance.

4. The computer-implemented method of claim 3, wherein said determining comprises determining whether the measured performance substantially corresponds to the target performance for a predetermined number of times.

5. The computer-implemented method of claim 3, wherein said determining comprises determining whether the measured performance substantially corresponds to the target performance for a predetermined period of time.

6. The computer-implemented method of claim 1, further comprising providing the user with a reference signal indicative of the target performance to be achieved during the physical activity.

7. The computer-implemented method of claim 1, wherein the media comprises one of a video and an interactive book.

8. The computer-implemented method of claim 1, wherein the media comprises an audio file comprising at least one audio track.

9. The computer-implemented method of claim 8, wherein said modifying comprises changing a playback position of the audio track.

10. The computer-implemented method of claim 9, wherein said changing the playback position is done when a transition time point is reached.

11. The computer-implemented method of claim 8, wherein the audio track comprises a plurality of audio track segments, and said modifying comprises one of selecting, adding, and removing a given audio track segment.

12. The computer-implemented method of claim of claim 8, wherein said modifying comprises one of modifying, removing, and adding at least one of a volume, an echo, a flanger, a chorus, an equalization, an audio filtering, an overdrive, a pitch shift, time stretching, a pitch, and a saturation.

13. The computer-implemented method of claim 8, wherein the audio track comprises a Musical Instrument Digital Interface (MIDI) audio track, and said modifying comprises modifying a parameter of the MIDI audio track, the parameter comprising one of a notation, a pitch, a transposition, a speed, a velocity, a volume, a pan, a vibrato, a sustain, and a tempo.

14. The computer-implemented method of claim 8, wherein the audio file is generated by one of a sound synthesizer, a sampler, and a sound generator unit, said modifying comprising modifying one of a pitch, a timber, an oscillator, a overdrive, an envelope, a transposition, a speed, a velocity, a volume, a pan, a vibrato, a sustain, and a tempo of the generated audio file.

15. A computer program product comprising a computer readable memory storing computer executable instructions thereon that when executed by a computer perform the steps of:
receiving from a performance sensor a measured performance of the user while performing a physical activity;
comparing the measured performance to a target performance;
upon successful comparison, modifying the media to be provided to the user; and
outputting the modified media.

16. A system for modifying a media, comprising:
an evaluation unit for receiving a measured performance of a user while performing a physical activity from a performance sensor, comparing the measured performance to a target performance, and upon successful comparison, outputting a command indicative of the successful comparison; and
a media modification unit operatively connected to the evaluation unit, for modifying a media to be provided to the user upon reception of the command, and outputting the modified media.

17. The system of claim 16, the evaluation unit is adapted to receive one of a frequency of a movement, a pace, a speed, a cadence, and a geographical position for the user.

18. The system of claim 16, wherein the media modification unit is adapted to determine whether the measured performance substantially corresponds to the target performance.

19. The system of claim 18, wherein the media modification unit is adapted to determine whether the measured performance substantially corresponds to the target performance for a predetermined number of times.

20. The system of claim 18, wherein the media modification unit is adapted to determine whether the measured performance substantially corresponds to the target performance for a predetermined period of time.

21. The system of claim 16, the evaluation unit is further adapted to provide the user with a reference signal indicative of the target performance to be achieved during the physical activity.

22. The system of claim 16, wherein the media comprises an audio file comprising at least one audio track.

23. The system of claim 22, wherein the media modification unit is adapted to change a playback position of the audio track.

24. The system of claim 23, wherein the media modification unit is adapted to change the playback position when a transition time point is reached.

25. The system of claim 22, wherein the at least one audio track comprises a plurality of audio track segments, and the media modification unit is adapted to one of select, add, and remove a given audio track segment.

26. The system of claim of claim 22, wherein the media modification unit is adapted to one of modify, remove, and add at least one of a volume, an echo, a flanger, a chorus, an equalization, an audio filtering, an overdrive, a pitch shift, time stretching, a pitch, and a saturation of the audio track.

27. The system of claim 22, wherein the audio track comprises a Musical Instrument Digital Interface (MIDI) audio track, and the media modification unit is adapted to modify a parameter of the MIDI audio track, the parameter comprising one of a notation, a pitch, a transposition, a speed, a velocity, a volume, a pan, a vibrato, a sustain, and a tempo.

28. The system of claim 22, wherein the audio modification unit comprises one of a sound synthesizer, a sampler, and a sound generator unit adapted to generate the audio file, and the media modification unit is adapted to modify one of a pitch, a timber, an oscillator, a overdrive, an envelope, a transposition, a speed, a velocity, a volume, a pan, a vibrato, a sustain, and a tempo of the generated audio file.
